(19) United States
(12) Patent Application Publication
(10) Pub. No.: US 2008/0019549 A1
(43) Pub. Date: Jan. 24, 2008

(54) SOFT IN-THE-EAR INSERT

(75) Inventor: Andre Lucien Ochsenbein, Wolfhausen (CH)

Correspondence Address: PEARNE & GORDON LLP, 1801 EAST 9TH STREET, SUITE 1200, CLEVELAND, OH, 44114-3108, US

(73) Assignee: PHONAK AG, Staefa (CH)

(21) Appl. No.: 11/458,506

(22) Filed: Jul. 19, 2006

(51) Int. Cl. H04R 25/00

(52) U.S. Cl. 381/325

(57) ABSTRACT

An in-the-ear plug-like insert to introduce and hold a sound signal or acoustic signal guiding and/or producing element or device respectively comprises an acoustic signal and/or sound signal output opening including portion at least partially consisting of an elastic or soft material, which portion further comprises integrated cerumen protection means, which are arranged inwardly displaced from the signal output opening within the portion.

The present invention refers to a soft in-the-ear insert to introduce and hold a sound signal or acoustic signal guiding and/or producing element or device respectively according the introduction of claim 1 and an in-the-ear acoustic or hearing device guiding, amplifying and/or producing acoustic or sound signal into the ear.

Soft ear-plug-like inserts to hold speakers, acoustic tubes, electronic audio ITE devices, etc. in the ear are known. Usually such inserts are provided to universally hold dimensioned elements which means that due to the soft construction an introduction of the mentioned elements in different and varying ear canal properties or characters is possible. Important is, that the holding insert element is protected against contamination as e.g. against cerumen. Therefore in various documents such as the DE 199 08 854, DE 196 40 796, DE 41 40 850, EP 1 596 631, DE 103 45 504 and DE 102 13 844 the arrangement of a cerumen protection at in-the-ear devices is described, which is mounted separately at the front end of an output opening of plug-like inserts.

One problem exists in case of front mounting of the protection against cerumen, as it can fall off the plug-like insert and remain within the ear canal. Furthermore the cerumen can form a layer covering the whole protection of the opening and therefore it can influence the quality of the output signal or the acoustic signal respectively. Finally front mounted cerumen protection means are usually quite expensive. It is therefore an object of the present invention to propose a solution for protecting any insert devices or elements, hold by a soft plug-like insert against cerumen, such as in-the-ear acoustic or hearing devices.

Accordingly an in-the-ear plug-like insert is proposed according the wording of claim 1.

Proposed is, that the ear plug-like insert to introduce and hold a sound signal or acoustic signal guiding and/or producing element or device respectively comprising an acoustic signal and/or sound signal output opening at least partially consisting of an elastic or soft material, further compromising integrated cerumen protection means, which is arranged displaced inwards from the signal output opening.

The idea is, that the cerumen protection for e.g. a receiver, an acoustic tube, a speaker, an electronic audio ITE device, etc. is directly integrated within the plug-like soft or elastic insert, which is holding the mentioned device or element in the ear canal. If the cerumen protection is integrated it can not fall off and eventually being stuck within the ear or even being lost.

The cerumen protection means can be e.g. disk-like, comprising a plurality of openings within the disk. The geometry of the various openings or sound output openings within the disk-like protection means can act like a thin thieve as cerumen protection which openings are chosen such, that there is practically no difference between having no protection or the mentioned cerumen protection.

The disk-like protection can also be perforated.

The cerumen protection is arranged within a tube of the plug-like insert, which tube is connected to the signal output opening, the protection being arranged at a distance from the signal output opening.

According a further design it is proposed, that an outwardly projecting dome-like or umbrella-like soft shield portion is arranged. It is even possible, that at the plug-like insert at the distance from the sound output opening and in line with the first shield at least a second outwardly protecting dome-like or umbrella-like soft portion is arranged. These outwardly projecting dome-like or umbrella-like soft shields are provided to hold the acoustic or sound signal guiding and/or producing element or device respectively in position within the ear canal.

Furthermore the plug-like insert may comprise a holding compartment for the arrangement of a speaker, a receiver, an amplifier unit, a hearing device, etch. This holding compartment may consist of an at least almost rigid material.

The insert itself could consist of a soft or elastic material such as an elastomeric polymer, silicon, etc.

The sound output opening maybe circular, square-like, triangle-like, etc.

Further preferred embodiments are described within the dependent claims. Also proposed is an acoustic signal or sound signal guiding, amplifying or producing device or element respectively comprising an integrated plug-like insert to hold the device or element at least almost firmly within the ear canal as described above.

The invention shall be described in more details by way of the examples as shown within the attached figures.

In the figures:

FIG. 1 shows a side view of an inventive plug-like insert,

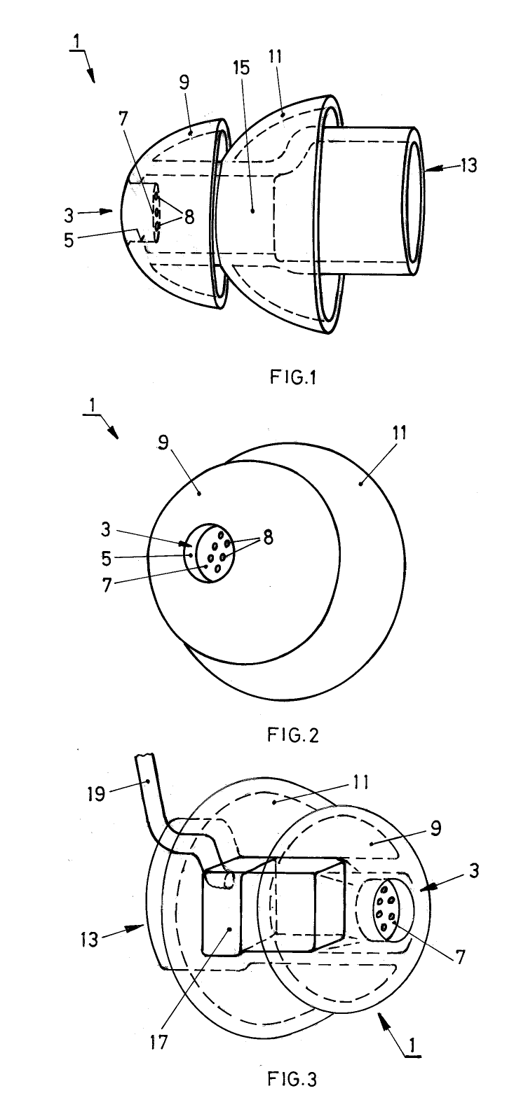

FIG. 2 shows the plug-like insert from FIG. 1 in a perspective view from the front side,

FIG. 3 shows a perspective side view of the plug-like insert according to FIG. 1,

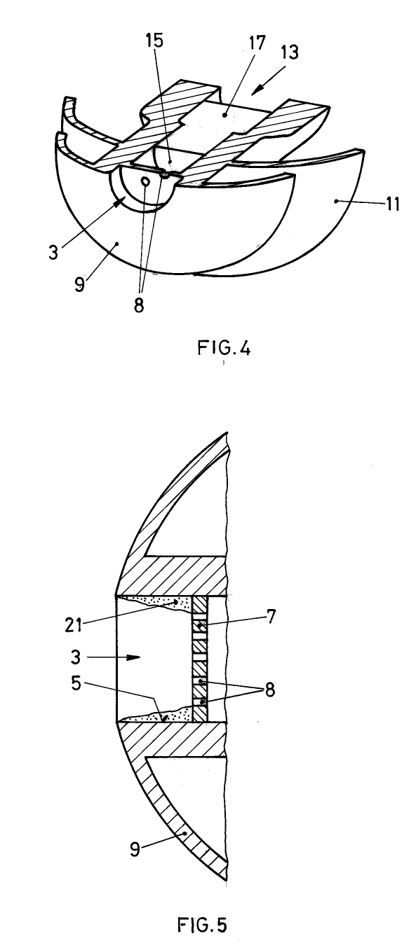

FIG. 4 shows an axial length wise sectional view trough the plug-like insert according to FIG. 1, and

FIG. 5 shows a cross-sectional view trough the front end and the signal output opening of the plug-like insert according to FIG. 1.

FIG. 1 shows in a perspective side an inventive in-the-ear plug-like insert 1 comprising at its front end a sound signal opening 3. Inwardly displaced from the output signal opening 3 within a tube-like canal 5 arranged is a disk-like cerumen protection 7 comprising a plurality of passage openings 8 for the passage of acoustic signals or sound signals.

The plug-like insert 1 further comprising a holding compartment 13 provided for holding an acoustic guiding, amplifying or producing device or element such as e.g. a speaker, a receiver, an amplifier, etc. of an in-the-ear hearing device. The compartment 13 is interconnected with the signal output opening and the tube-like cannel 5 via an interconnection tube 15.

The plug-like insert further comprises outwardly projecting dome-like or umbrella-like shields 9 and 11, which are provided to keep the plug-like insert in position within an ear canal. Especially these dome-like or umbrella-like protections are consisting of a soft or elastic material such as an elastomeric polymer, silicon, etc. so that e.g. an acoustic device such as a speaker, receiver, an amplifier, etc. placed within the compartment 13 can be inserted into different kinds of ear channels comprising different characteristics or profiles of an ear canal. In case of having two projections as shown in FIG. 1 a firm positioning within an ear canal is possible.

Within FIG. 2 a perspective view from the front end of the inventive insert 1 is shown. The cerumen protection 7 comprising the sound signal passages 8 can be seen very clearly within the tube-like canal 5, inwardly displaced from the front end sound output opening 3.

Within FIG. 3 an other side perspective view of the plug-like insert 1 is shown with the holding compartment 13 being transparent, so that an acoustic device or element 17 can be seen. This element can be e.g. a speaker, a receiver, an amplifier, a in-the-ear hearing device, etc., which in case of FIG. 3 is connected with e.g. further acoustic or sound creating elements outside the ear via a tube 19. The further elements of the plug-like insert are provided with the same referential numbers as shown in FIGS. 2 and 1.

FIG. 4 shows a cut off or lengthwise sectional view of the plug-like insert showing the acoustic device or element 17 inserted within the holding compartment 13. An output signal or sound signal from the acoustic device or element 17 can be transferred via the intersection 15 trough the cerumen protection 7 to the signal output opening 3 of the plug-like insert.

FIG. 5 finally shows the area of the sound output opening 3 of the inventive plug-like insert in sectional view. Within the tube-like canal 5 displaced from the sound output opening the cerumen protection 7 is arranged comprising the sound passages or holes 8. In FIG. 5 it can be recognised very clearly, that any cerumen 21 is kept outside of the intersection 15 connecting the signal output opening 3 to the acoustic device or element and furthermore the deposited cerumen 21 does not cover the cerumen protection 7 and in particular the passages 8 for the passage of the sound signals. Therefore a great advantage of placing the cerumen protection 7 displaced from the front sound output opening is, that it is not covered by the cerumen.

As a consequence the plug-like insert as proposed according the present invention has to be replaced substantially less frequently as a insert as proposed in the art, where the cerumen protection is covering the front end opening.

1. In-the-ear plug-like insert to introduce and hold a sound signal or acoustic signal guiding and/or producing element or device respectively, the insert comprising an acoustic signal and/or sound signal output opening, including a portion at least partially consisting of an elastic or soft material, further comprising integrated cerumen protection means which are arranged displaced inward from the signal output opening within the portion.

2. Insert according to claim 1, the means is disk-like comprising a plurality of openings within the disk.

3. Insert according to claim 1, the means is disk-like, which disk is perforated.

4. Insert according to claim 1, the means is arranged within a tube extending through the portion of the insert connected to the signal output opening at a distance inwardly displaced from the opening.

5. Insert according to claim 1 characterized in, that at the portion in the region of the sound output opening an outwardly projecting dome-like or umbrella-like soft shield portion is arranged.

6. Insert according to claim 5 characterized in that at a distance from the sound output opening and in line with the first shield portion at least a second outwardly projecting dome-like or umbrella-like soft shield portion is arranged.

7. Insert according to claim 1, further comprising a holding compartment for the arrangement of a speaker, receiver, an amplifier unit, part of an ITE or BTE hearing device, etc.

8. Insert according to claim 7, the holding compartment consisting of an at least almost rigid material.

9. Insert according to claim 1, at least part of the insert consisting of a soft or elastic material such as an elastomeric polymer, silicon rubber, etc.

10. Insert according to claim 1, the sound output opening is circular, square-like, triangle-like, etc.

11. Insert according to claim 2 characterised in that the openings within the disk-like cerumen protecting means are mainly arranged in the center of the disk.
